(19) United States
(12) Patent Application Publication
(10) Pub. No.: US 2005/0265707 A1
(43) Pub. Date: Dec. 1, 2005

(54) Shadow free camera

(76) Inventor: Kuang-Yung Chang, Feng Yuan City (TW)

Correspondence Address: TROXELL LAW OFFICE PLLC;SUITE 1404, 5205 LEESBURG PIKE, FALLS CHURCH, VA, 22041, US

(21) Appl. No.: 10/855,616

(22) Filed: May 28, 2004

(51) Int. Cl. G03B 15/06

(52) U.S. Cl. 396/199

(57) ABSTRACT

A camera free of side shadow to effectively eliminate any side shadow appearing against the background of the object in the picture taken by having mounted one or multiple light projection devices arranged on the peripheral of the camera body and scattered around the lens of the camera or forthwith on the peripheral of the lens to create radiation overlapped light projection sources to fully eliminate any possible side shadow developed in the background of the object in the picture taken.

### BACKGROUND OF THE INVENTION

(a) Field of the Invention

The present invention is related to a camera, and more particularly, to one that completely eliminates the side shadow that may be developed of the objective due to flash is used to take pictures indoors.

(b) Description of the Prior Art

Most of the cameras generally available in the market are each adapted with a single point electronic flashtube or a flashcube or a flash bulb (built-in or an externally connected) to the upper left, upper right or straight up of the camera body. When taking pictures indoors, usually the flash is activated due to insufficient light. Since the object taken is usually at where against or closer to a wall or other barrier and the camera of the prior art works on spot projection, a angle of deviation exists between the lens and the projection device, i.e. the flash. Accordingly, an extremely side shadow is developed on the background (i.e., the wall or other barrier) of the object resulted from single side projection.

As illustrated in FIG. 20 of the accompanying drawings for a photo of a person 10 taken indoors with the camera of the prior art, the side shadow appears to the left of the contour of the person 10 since the flash is adapted to the right side of the camera; similarly, the side shadow 20 appears to the right of the contour of the person 10 when the flash is adapted to the left side of the camera as illustrated in FIG. 21. The conspicuous appearance of the side shadow 20 on the photo usually taken indoors does present an uncomfortable and annoying feeling to its viewers.

### SUMMARY OF THE INVENTION

The primary purpose of the present invention is to provide a camera that takes pictures without developing any undesired side shadow. To achieve the purpose, a single circular light projection device is provided to the camera body or directly provided surrounding the peripheral of the lens, or multiple light projection devices are provided surrounding on the camera body or on the peripheral of the lens so to create radiation overlapped light projection sources when a picture is taken indoors for complete elimination of the side shadow to the object, and thus, a more clear and integral shot of the object.

Another purpose of the present invention is to provide a camera that takes pictures without developing any undesired side shadow. Wherein, the single or multiple light projection devices is built in or externally assembled to a selected position on the camera body or on the peripheral of the lens.

### BRIEF DESCRIPTION OF THE DRAWINGS

FIG. 1 is a schematic view showing a preferred embodiment of the present invention adapted with a circular light projection device on the body of a camera.

FIG. 2 is a perspective view showing the preferred embodiment of the present invention.

FIG. 3 is a perspective view of another preferred embodiment of the present invention adapted with a circular light projection device on. the peripheral of a fixed lens.

FIG. 4 is a perspective view of another preferred embodiment of the present invention adapted with a circular light projection device on the peripheral of a zoom lens.

FIG. 5 is a perspective view of another preferred embodiment yet of the present invention adapted with a circular light projection device on the peripheral of a zoom lens.

FIG. 6 is a schematic view of another preferred embodiment yet of the present invention with two light projection devices respectively adapted to the top and the bottom of the camera body.

FIG. 7 is a schematic view of another preferred embodiment yet of the present invention with two light projection devices respectively adapted to the left side and the right side of the camera body.

FIG. 8 is a schematic view of another preferred embodiment yet of the present invention with multiple light projection devices arranged in a circle on the camera body.

FIG. 9 is a schematic view of another preferred embodiment yet of the present invention with multiple light projection devices in a number even greater than that as illustrated in FIG. 8 arranged in a circle on the camera body.

FIG. 10 is a perspective view of the preferred embodiment of the present invention as illustrated in FIG. 9.

FIGS. 11 through 14 are schematic views of other preferred embodiments yet of the present invention adapted with multiple light projection devices in various circular arrangements on the camera body.

FIG. 15 is a perspective view of the preferred embodiment of the present invention as illustrated in FIG. 13.

FIGS. 16 through 19 are schematic views showing other preferred embodiments yet of the present invention with multiple light projection devices scattered around a sidewall of the camera body.

FIG. 20 is a schematic view showing a side shadow appearing to the left side of a person in the photo.

FIG. 21 is a schematic view showing a side shadow appearing to the right side of a person. in the photo.

### DETAILED DESCRIPTION OF THE PREFERRED EMBODIMENTS

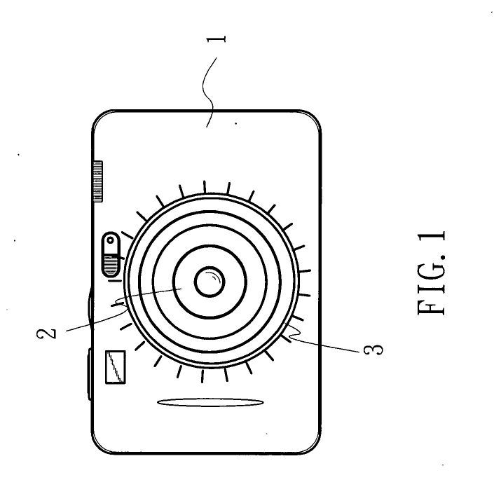

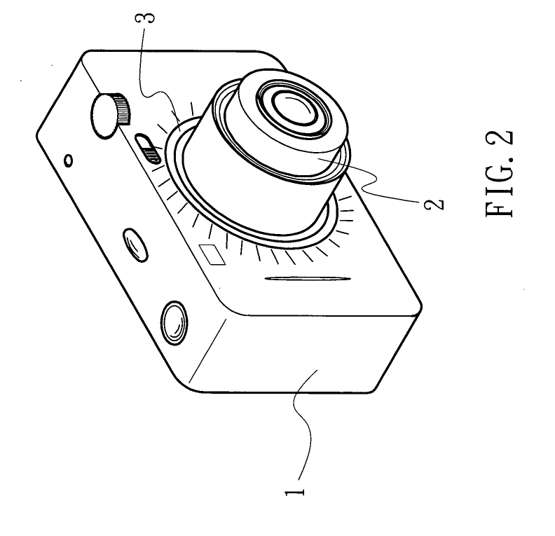

Referring to FIGS. 1 and 2, a preferred embodiment of the present invention of a camera 1 that completely eliminates side shadow on the photo is essentially comprised of a circular light projection device 3 (or a flash) provided on the camera body around the peripheral of a lens 2 for the light projection device 3 to create radiation overlapped projection light source to enable the lens 2 to completely eliminate any side shadow appearing against the background of an object on the photo taken particularly indoors.

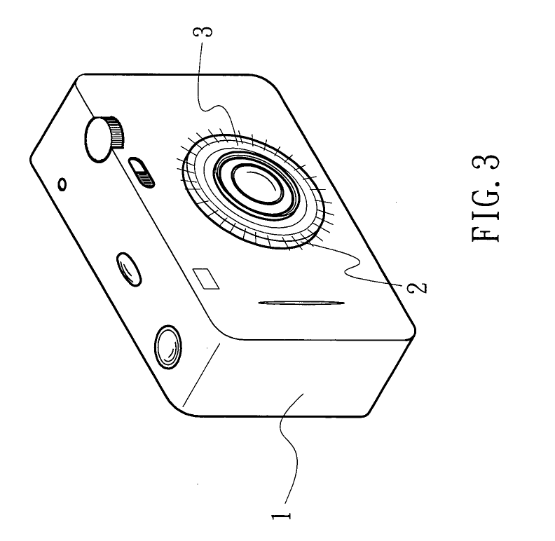

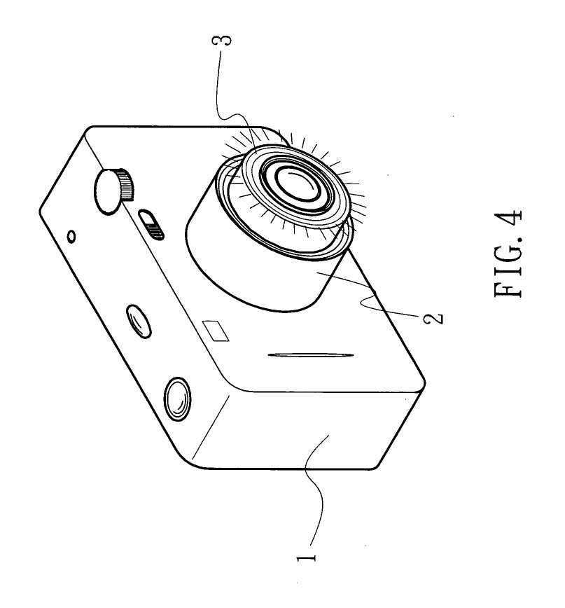

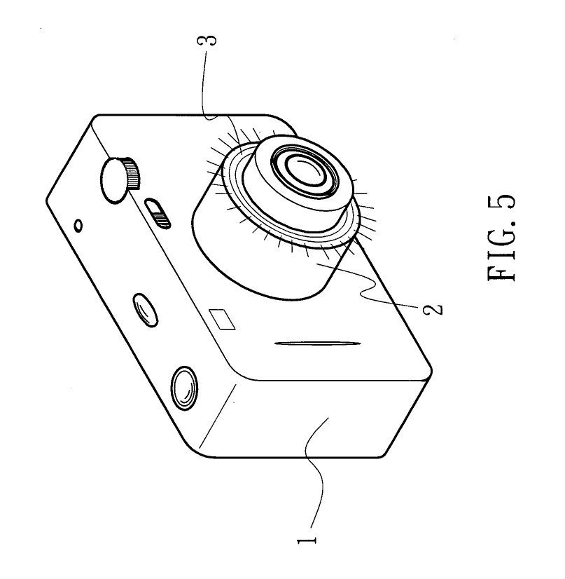

The light projection device 3 is related to a circular light projection device 3 mounted on the body of the camera 1 and is arranged surrounding the lens 2; or alternatively as illustrated in FIGS. 3, 4 and 5, the circular light projection device 3 is forthwith mounted to the peripheral of the fixed or a zoom lens 2 to create radiation overlapped light projection source for eliminating the side shadow appearing against the background of the object thus to avail an even clearer and more integral picture of the object.

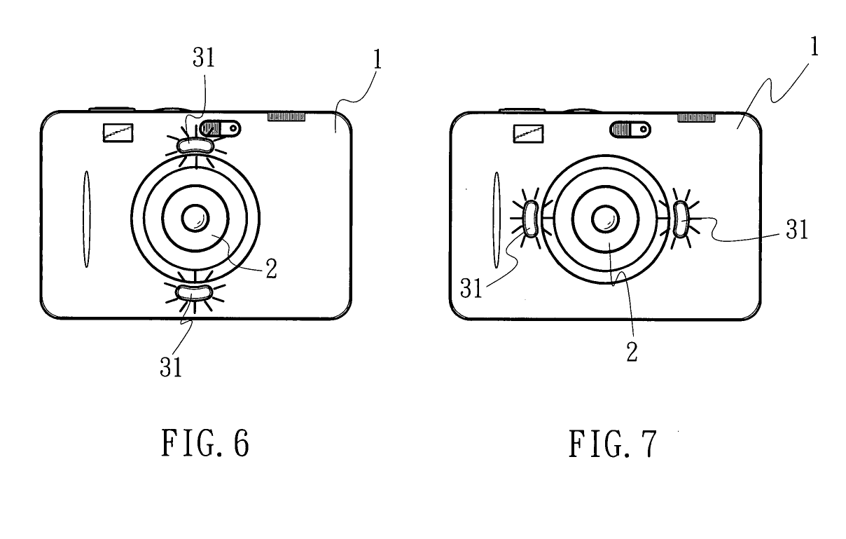

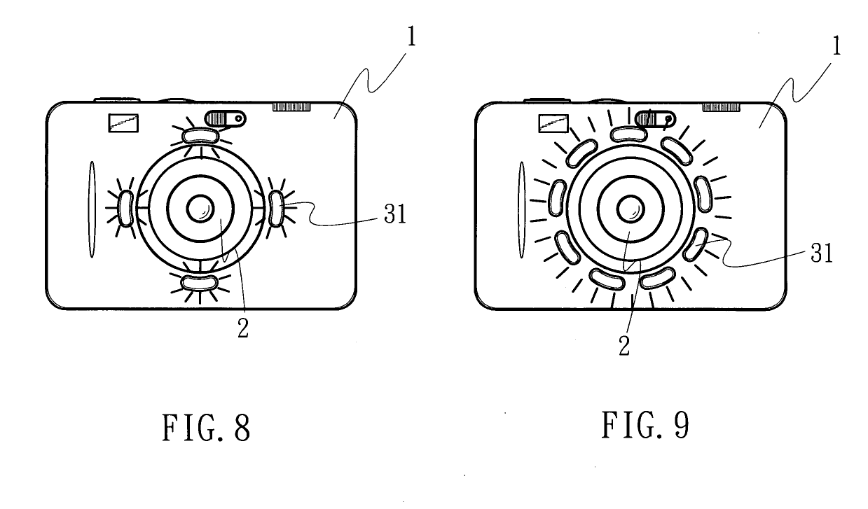

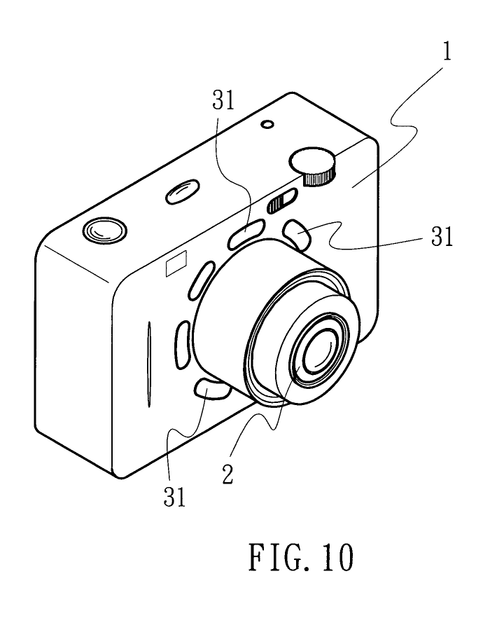

Similarly, multiple light projection devices 31 are arranged in circular fashion on the peripheral of the body of the camera 1. Those multiple light projection devices 31 are arranged surrounding the lens 2 as illustrated in FIGS. 6 and 7. Wherein, as illustrated in FIGS. 8 and 10, two light projection devices 31 are arranged in symmetry vertically or laterally around the lens 2, or more than two light projection devices 31 are arranged surrounding the lens 2 for the single light projection device 3 or those multiple light projection devices 31 to create radiation overlapped light projection source(s) when taking photos indoors for eliminating the side shadow appearing against the background of the object thus to avail an even clearer and more integral picture of the object.

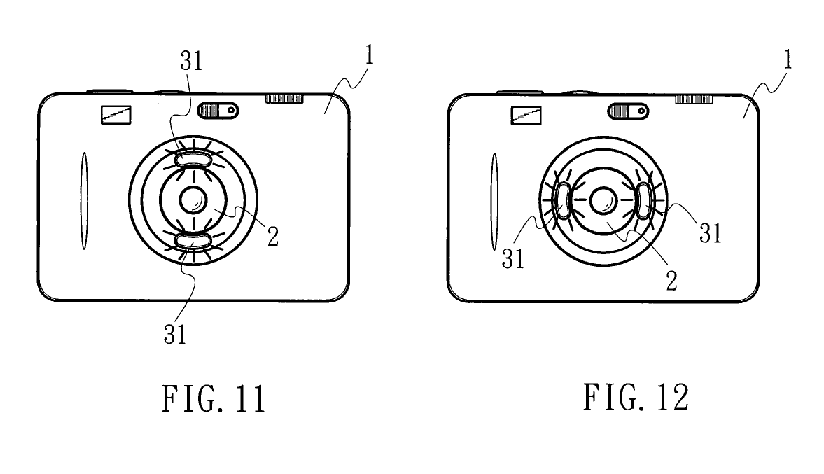

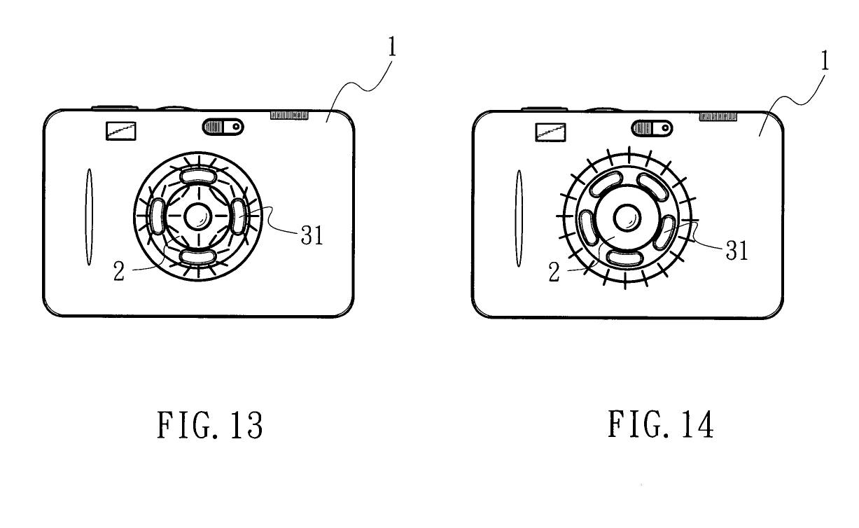

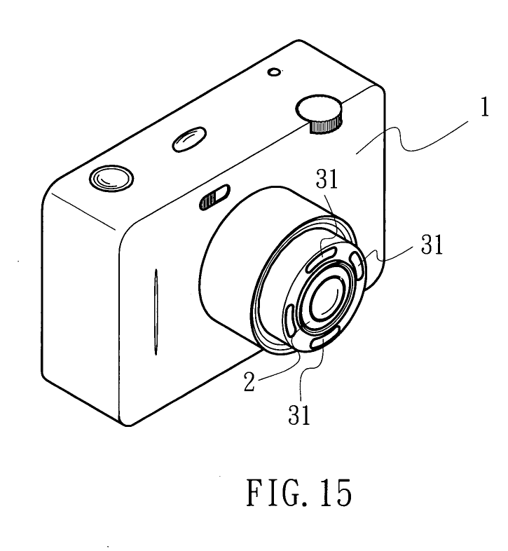

The light projection device 3 or 31 as described above has a single or multiple light projection devices 3 or 31 provided at where selected on the body of the camera 1 as long as it or they are located at where surrounding the lens 2. However, with the same teaching of the present invention, the light projection device 3 or light projection devices 31 can be forthwith adapted to the peripheral of a zoom or fixed lens 2 as respectively illustrated in FIGS. 11 through 15 to create radiation overlapped light sources for eliminating the side shadow appearing against the background of the object 4 thus to avail an even clearer and more integral picture of the object, particularly when taken indoors.

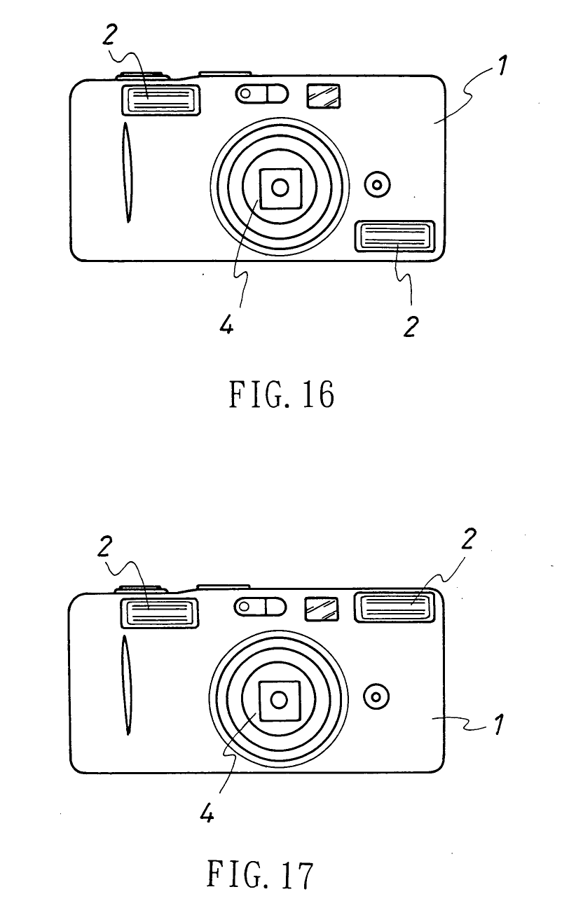

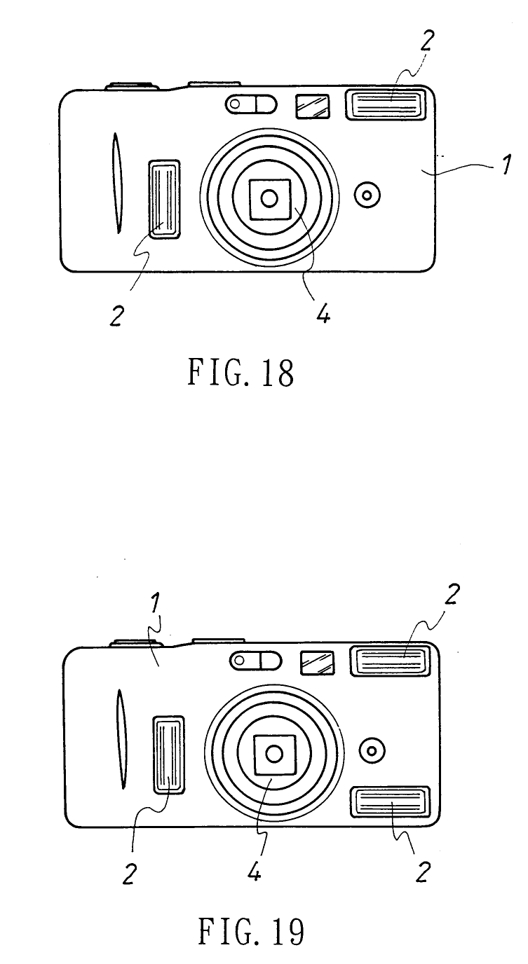

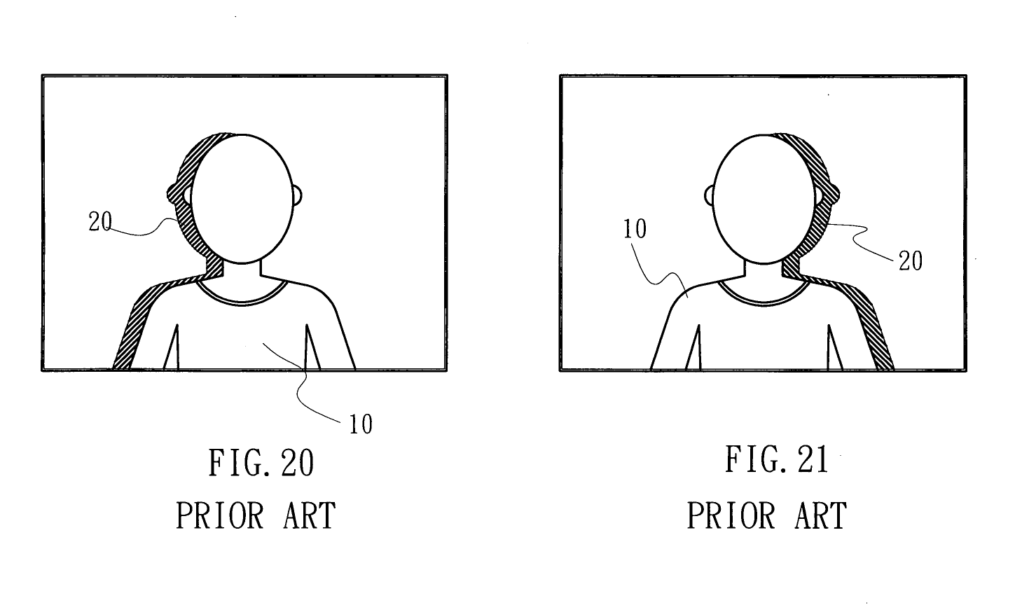

Furthermore, as illustrated in FIGS. 16 through 19, multiple light projection devices 31 are scattered around various locations on the side wall of the camera body and surrounding the lens to achieve the same purpose of creating radiation overlapped light sources when taking pictures indoors to eliminate the side shadow developed against the background of the object.

The present invention can be also applied in the conventional camera, digital camera, cellular phone, wrist watch or other associate items where a camera is adapted to create the radiation overlapped light projection source for eliminating the side shadow appearing in the background of the object. Therefore, it is to be noted that the design of a camera free of side shadow disclosed by the present invention does not in any way restrict the scope of the teaching of the present invention, and that any replacement or substitutive art with equivalent results shall be deemed as falling with the characteristics of the present invention.

1. A camera free of side shadow is characterized by having provided one circular light projection device or multiple light projection devices arranged on the peripheral of a body of the camera or forthwith surrounding the peripheral of a lens of the camera to create radiation overlapped light projection source to fully eliminate any side shadow developed against the background of an object in the picture taken.

2. A camera free of side shadow as claimed in claim 1, wherein, the light projection relates to a single circular light projection device mounted on the peripheral of the camera body and surrounding the lens of the camera.

3. A camera free of side shadow as claimed in claim 1, wherein, the light projection relates to a single circular light projection device forthwith mount of the peripheral of the lens of the camera.

4. A camera free of side shadow as claimed in claim 3, wherein, the lens of the camera relates to a fixed lens.

5. A camera free of side shadow as claimed in claim 3, wherein, the lens of the camera relates to a zoom lens.

6. A camera free of side shadow as claimed in claim 1, wherein, multiple light projection devices are mounted on the peripheral of the camera body and scattered around the lens of the camera.

7. A camera free of side shadow as claimed in claim 1, wherein, multiple light projection devices are mounted on the peripheral and scattered around the lens of the camera.
